(19) United States
(12) Patent Application Publication
(10) Pub. No.: US 2002/0098074 A1
(43) Pub. Date: Jul. 25, 2002

(54) Cross-stacker

(75) Inventors: Gunter Gammerler, Gelting (DE); Ronald Meisel, Kochel am See (DE); Peter Kunz, Geretsried (DE)

Correspondence Address: FITCH EVEN TABIN AND FLANNERY, 120 SOUTH LA SALLE STREET, SUITE 1600, CHICAGO, IL, 60603-3406, US

(73) Assignee: Gammerler AG

(21) Appl. No.: 10/005,982

(22) Filed: Dec. 3, 2001

(30) Foreign Application Priority Data
Dec. 4, 2000 (DE) 100 60 180.4

(51) Int. Cl. B65G 57/00

(52) U.S. Cl. 414/788.3; 414/790.3; 414/791.2; 414/790.2

(57) ABSTRACT

A cross-stacker for paper products has a pre-collection chamber, at least one rotation device and two ejection devices, with a transport device being provided beneath the pre-collection chamber which transports paper products collected in the pre-collection chamber.

The present invention relates to a cross-stacker for paper products having a pre-collection chamber for the formation of individual layers of printed products, at least one rotation device to rotate the layers formed through 180° and at least two ejection devices for the ejection of printed products from the rotation device.

Such cross-stackers are known from the prior art and can have two pre-collection chambers and two rotation devices which are charged with supplied paper products via a switch. While such an arrangement has proved itself in principle, the construction effort for the switch required in this respect is relatively large.

It is the object of the present invention to further develop a cross-stacker in accordance with the preamble of claim 1 which has more than one ejection device such that an at least unchanged work performance is possible with a reduced construction effort. This object is satisfied by the features of claim 1 and in particular by a transport device being provided beneath the pre-collection chamber which alternately transports the paper products collected in the pre-collection chamber to one of at least two ejection positions.

In accordance with the invention, the layers formed in the pre-collection chamber can be transported to one of two ejection positions with the aid of the transport device such that product stacks, which are rotated by 180° in each case, can be picked at two positions even though only one pre-collection chamber is provided.

Advantageous embodiments of the invention are described in the description, the drawings and the dependent claims.

In accordance with an advantageous embodiment, the transport device can have a displacement station which is provided in particular with two receiving chambers. The layers formed in the pre-collection chamber can be alternately transported to two rotation devices by such a displacement station such that two rotations devices can be charged from one pre-collection chamber.

It is generally of advantage for the transport device to have a receiving chamber for the paper products to be transported since these are then protected and held during transport, which takes place at high speed.

In accordance with a further advantageous embodiment, the transport device has at least one vertically movable lifting device. It is possible in this way to “pick up” the paper products released from the receiving chamber without these dropping a significant distance. The lifting device can, for example, have the shape of a positioning cylinder or the shape of vertically movable rake pairs.

It is particularly advantageous for the transport device to have a clamping device in order to clamp the paper products during transport. Since the transport of the paper products takes place at high speeds inside the transport device, such a clamping device helps to maintain the desired stack shape in the form of a parallelepiped even when the paper products are moved at high speeds. Such a clamping device can have clamping members which are set at the upper side of the stack. It is also possible to provide walls at the transport device which can be set in the direction of the stack in order to preclude a relative movement of individual paper products during transport.

In accordance with a further advantageous shape, the transport device has at least one pivot station on which a rotation device is arranged. With such an embodiment, the paper products released from the pre-collection chamber can be conveyed to the respective ejection position via a pivot movement, with it being possible to design the pivot station such that a reorientation of the printed products through 80° is carried out during the transport movement. It is alternatively possible to arrange two rotation units downstream of the transport device, with the part layers formed in the pre-collection chamber being able to be rotated through 180° in each case in these.

It is particularly advantageous for the cross-stacker of the invention to have only one single pre-collection chamber. In this case, the construction effort is low even though finished product stacks can be picked from the cross-stacker at two ejection positions.

The present invention is described purely by way of example in the following with reference to advantageous embodiments and to the enclosed drawings. There are shown:

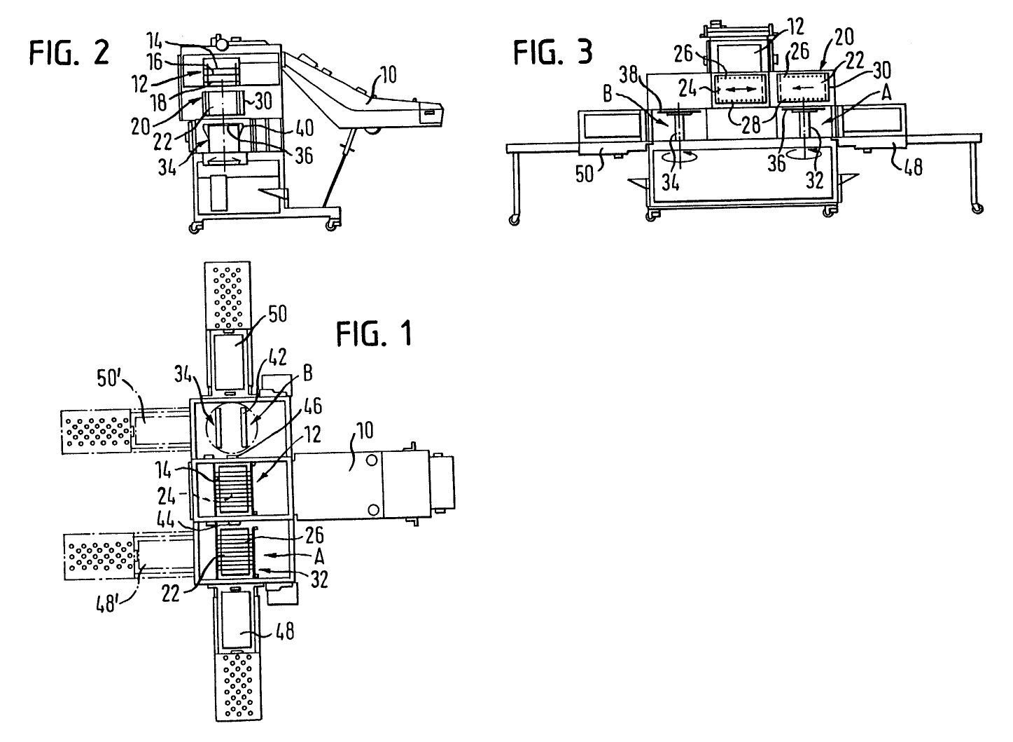

FIG. 1 a plan view of a first embodiment of a cross-stacker;

FIG. 2 a side view of the cross-stacker of FIG. 1;

FIG. 3 a further side view of the cross-stacker of FIGS. 1 and 2; and

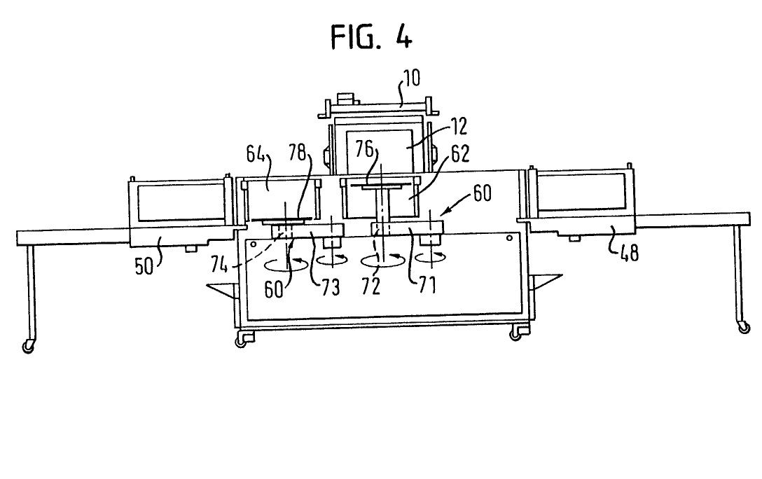

FIG. 4 a side view corresponding to FIG. 3 of a further embodiment of a cross-stacker.

The cross-stacker represented in FIGS. 1 to 3 has a supply belt 10 which supplies a stream of paper products arranged in an overlapping manner to a pre-collection chamber 12. A total of three levels of rake pairs 14, 16, 18 are provided in the pre-collection chamber 12 and the paper products falling into the pre-collection chamber are temporarily collected on these in order to form individual layers.

A transport device 20 is arranged beneath the pre-collection chamber 12 and serves to alternately transport paper products collected in the pre-collection chamber 14 to one of two ejection positions A and B.

In the represented embodiment, the transport device 20 has a displacement station which is provided with two receiving chambers 22, 24, with each receiving chamber 22, 24 having a plurality of rake pairs 26, 28 which can open and close and which can be lowered or raised vertically via a lifting device 30 in the region of the receiving chambers 22, 24.

The two receiving chambers 22, 24 can be jointly displaced horizontally in the displacement station of the transport device 20 such that either the receiving chamber 24 comes to rest beneath the pre-collection chamber 12, as is illustrated in FIG. 3, or such that the receiving chamber 22 is arranged beneath the pre-collection chamber 12. In the first case, the receiving chamber 22 is located above a first rotation device 32, while in the latter case the receiving chamber 24 is arranged above a second rotation device 34.

Both rotation devices 32 and 34 have a rotating table 36, 38 which can be turned by 180° in each case about a vertical axis. At the same time, the rotating table can be raised or lowered along the rotational axis via a positioning cylinder.

A clamping device 40, 42 respectively is arranged above each rotation table 36, 38 (cf. FIGS. 1 and 2) and the product stack located on the rotating table 36, 38 can be clamped during rotation with its help.

Finally, one ejector 44, 46 each is provided in the region of the ejection positions A and B and respectively conveys a product stack which has been completed onto an associated discharge table 48, 50. Alternative positions for the discharge tables are indicated by the reference numerals 48′ and 50′.

The function of the embodiments described in FIGS. 1 to 3 will be explained in the following.

In the embodiment shown in FIGS. 1 to 3, the product stream of paper products arranged in an overlapping manner and supplied via the supply belt 10 is first guided into the pre-collection chamber in which the individual paper products first fall onto the topmost rake pair 14. Subsequently, in a manner known to one skilled in the art, a layer of printed products oriented in the same direction is formed in the pre-collection chamber 12 by the rakes of the individual rake pairs 14, 16 and 18 being successively opened. After a layer of a desired height has been formed on the bottommost rake pair 18, the bottommost rake pair 18 opens and the layer is passed on to the transport device 20 arranged beneath the pre-collection chamber 12.

In the position of the transport device 20 represented in FIGS. 1 to 3, the receiving chamber 24 is located directly beneath the pre-collection chamber 12, with the rake pair 26 being closed and being located in the topmost position within the receiving chamber 24. In this way, when the rake pair 18 of the pre-collection chamber 12 is opened, the layer located thereon is passed onto the rake pair 26 of the receiving chamber 24 without a significant distance having to be covered in free fall.

After the layer formed in the pre-collection chamber 12 has been passed on to the receiving chamber 24, this layer is lowered in the receiving chamber 24 and passed on to the lower rake pair 28 in the receiving chamber 24. Meanwhile, the transport device 20 is displaced such that the receiving chamber 24 comes to rest above the second rotation device 34 and the receiving chamber 22 comes to rest beneath the pre-collection chamber 12. Subsequently, the receiving chamber 22 can take over a layer from the pre-collection chamber 12, while the layer located in the receiving chamber 24 is passed on to the second rotation device 34 by the rake pair 28 being opened so that the layer can fall onto the rotating table 38 with only a small fall distance. Subsequently, the clamping device 42 is actuated and the rotating table 38 lowered so that the layer is fixed on the rotating table 38. Subsequently, the rotating table is turned through 180° so that when the next layer is taken over, an arrangement offset by 180° in each case is ensured. In this way, a compensation of the height differences caused by the fold of the printed products is achieved in a known manner.

In the manner described above, the layers formed in the pre-collection chamber 12 are alternately passed on to the rotating tables 36, 38 until the desired final stack height is achieved. Thereupon, the respective rotating table is fully lowered so that the bundle formed can be ejected onto the associated discharge table 48, 50 with the aid of the ejector 44 or 46.

FIG. 4 shows a second embodiment of the invention, with the same reference numerals being used for the same parts.

In the embodiment of a cross-stacker illustrated in FIG. 4, the stream of paper products arranged in an overlapping manner is conveyed via the supply belt 10 into the pre-collection chamber 12 in which three rake pairs are provided in the same manner as in the first embodiment. A transport device 60, which has two pivot stations 71 and 73 arranged next to one another, is provided directly beneath the pre-collection chamber 12. A receiving chamber 62 is rotatably secured on the pivot station 71 above a first rotation device 72. A receiving chamber 64 is likewise pivotally arranged on the pivot station 73 above a second rotation device 74. Both receiving chambers 62 and 64 can be pivoted around vertical axes with the aid of the rotation devices. Furthermore, rotating tables 76, 78 are respectively provided in the receiving chambers 62 and 64 and can be moved up and down vertically via lifting devices (not shown) inside the receiving chambers. In the illustration of FIG. 4, the rotating table 78 is located in the bottommost position in the receiving chamber 64, whereas the rotating table 76 has moved to the topmost position in the receiving chamber 62.

Moreover, in the same way as in the first embodiment, clamping devices (not shown) are provided in both receiving chambers 62 and 64 which clamp the paper products located on the respective rotating table so that when the receiving chambers 62, 64 and/or the pivot stations 71, 72 are rotated, the desired orientation and alignment of the paper products is maintained.

In the embodiment shown in FIG. 4, the paper products are conveyed by the supply belt 10 into the pre-collection chamber 12 and a layer is formed there in the same way as in the first embodiment. The fully formed layer is subsequently passed on to the rotating table 76 of the receiving chamber 62 which has been moved to the upper position shown in FIG. 4. Subsequently, the receiving chamber 62 is rotated through 180° with the aid of the rotation device 72 so that the following layer coming from the pre-collection chamber 22 can be put down offset by 180°. The rotating table 76 is simultaneously lowered downwardly in accordance with the layers passed on until the desired bundle height is reached. Subsequently, the pivot station 71 is pivoted around its vertical pivot axis such that the receiving chamber 62 is located in the ejection position in which an ejector (not shown) conveys the finished bundle onto the discharge table 48. The stack of paper products located inside the receiving chamber is clamped with the aid of the clamping device (not shown) during the rotating movement of the receiving chamber 62 and of the pivot station 71.

Simultaneously with the pivoting of the pivot station 71 out of the region beneath the pre-collection chamber 12, the pivot station 73 is pivoted into this region so that subsequently formed layers can be passed on into the receiving chamber 64 without interruption. The cycle here is continued in the manner described above such that the supplied paper products are first stacked to form layers and subsequently to form bundles with layers offset by 180° without interruption.

1. A cross-stacker for paper products, comprising
a pre-collection chamber (12) for the formation of individual layers of printed products;
at least one rotation device (32, 34; 72, 74) to rotate the layers formed through 180°; and
at least two ejection devices (44, 46) to eject printed products from the rotation device,
characterized in that a transport device (20, 60) is provided beneath the pre-collection chamber (12) which alternately transports the paper products collected in the pre-collection chamber (12) to one of at least two ejection positions (A, B).

2. A cross-stacker in accordance with claim 1, characterized in that the transport device (20) has a displacement station which is in particular provided with two receiving chambers (22, 24).

3. A cross-stacker in accordance with claim 1, characterized in that the transport device (20, 60) has a receiving chamber (22, 24; 62, 64) for the paper products to be transported.

4. A cross-stacker in accordance with claim 1, characterized in that the transport device (20, 60) has at least one vertically movable lifting device (30).

5. A cross-stacker in accordance with claim 1, characterized in that the transport device has a clamping device (40, 42) in order to clamp the paper products during transport.

6. A cross-stacker in accordance with claim 1, characterized in that the transport device (60) has at least one pivot station (71, 73) on which a rotation device (72, 74) is arranged.

7. A cross-stacker in accordance with claim 1, characterized in that two rotation devices (32, 34) are arranged downstream of the transport device (20).

8. A cross-stacker in accordance with claim 1, characterized in that only a single pre-collection chamber (12) is provided.
